(19) United States
(12) Patent Application Publication
(10) Pub. No.: US 2012/0004884 A1
(43) Pub. Date: Jan. 5, 2012

(54) DEVICE AND METHOD FOR THE SPACE-COLORIMETRIC MEASUREMENT OF A THREE-DIMENSIONAL OBJECT

(76) Inventors: Bernard Fillol, Paris (FR); Philippe Gremillet, Soisy Sur Seine (FR); Jean-Marie Magain, Saint Leu (FR); Jean Tretout, Montataire (FR); Frédéric Weimann, Senlis (FR)

(21) Appl. No.: 12/864,132

(22) PCT Filed: Jan. 23, 2008
(86) PCT No.: PCT/FR08/00081

§ 371 Date: Jul. 21, 2011

(51) Int. Cl. G06F 15/00; G01J 3/40

(52) U.S. Cl. 702/150; 356/404

(57) ABSTRACT

The disclosure relates to a device and a method for the space-colorimetric measurement of a three-dimensional object, in order to digitally model the low-relief and the colorimetric coordinates of this object according to multiple analysis points. In order to do so, the measuring device of the disclosure combines a lighting means with at least four optical detection means, including at least two twin detection means sensitive to substantially identical light wavelength ranges, in order to determine by stereoscopic effect the low-relief of the object analysed. The disclosure thus proposes a device for the space-colorimetric measurement of a three-dimensional object, that comprises a detection head including a lighting means for the object and at least four detection means for detecting the light reflected by the object, wherein said device further includes a unit for processing the information received by the detection means. At least two twin detection means are sensitive to substantially identical light wavelength ranges.

### CROSS-REFERENCE TO RELATED APPLICATIONS

This application is a National Phase Entry of International Application No. PCT/FR2008/000081, filed on Jan. 23, 2008, which is incorporated by reference herein.

### BACKGROUND AND SUMMARY

The invention relates to a device and a method for a non-invasive, space-colorimetric measurement of a low-relief three-dimensional object. In this regard, the present invention relates to the space-colorimetric diagnostic field, also called colorimetric metrology field.

There has been known from the prior art various solutions allowing to analyze the colorimetric characteristics of a two-dimensional object. For example, dental surgeons and prosthetists use apparatuses that make it possible to precisely define a colorimetric cartography of teeth in order to produce prostheses exhibiting substantially the same colorimetric characteristics as the original teeth. In order to do this, it is essential to precisely pick the colorimetry of a tooth according to a plurality of analysis points.

In this regard, document No. WO 05/080929 shows a device for measuring the colorimetric characteristics of a tooth in a plurality of points and in a two-dimensional space. In the same manner, document No. WO 06/002703 discloses a device comprised of several light-emitting diodes that emit differently-colored light beams on an object. The light beams are then reflected by the object and then received by a detection system and a central image processing unit. Thus, each point of the image is analyzed in such a way as to determine the spectrum constituted of various levels of colors corresponding to the different wavelengths emitted from the light-emitting diodes. Based on these color levels, the central processing unit calculates, for each point of the analyzed surface, the corresponding colorimetric coordinates. Thus, the device described in this document makes it possible to determine a two-dimensional colorimetric cartography of the analyzed object.

However, these solutions are not satisfactory in as far as the relief, or topology of the analyzed objects, is not taken into account during the measurements. Because of this, the devices of the prior art calculate the colorimetric coordinates of objects considered as planes by approximation. Yet, the combination of spatial and colorimetric measurements for three-dimensional objects exhibits a wide range of applications in the dental field, biometry, industrial or artistic metrology, etc. More specifically, the fact of simultaneously measuring spatial and colorimetric coordinates according to three directions in space of the analyzed object allows to substantially improving the quality of the results.

In fact, the value of the colorimetric coordinates directly depends on the position of the measured object with respect to lighting means since the quantity of light received by an object decreases proportionally to the square of the distance which separates it from these lighting means. Likewise, the higher the angle between the ray of light and the normal to the object is, the lower the quantity of reflected light, within the scope of a scattered reflection, is. Because of this, the approximations carried out by the devices of the prior art generate significant errors which denature at least partially the quality of the colorimetric analysis carried out.

Another difficulty pertaining to the colorimetric measurement comes from the choice of lighting of the object to be analyzed. In fact, it is preferable to use lighting means that allow performing a splitting of the light flux according to predetermined geometric and chromatic criteria. However, this choice depends on criteria of quality, expense, encumbrance and life span.

The present invention aims to overcome the aforementioned drawbacks of the prior art by providing a device and a method for the space colorimetric measurement of a three-dimensional object allowing to digitally model the low-reliefs and the colorimetric coordinates of this object based on a multitude of analysis points. Also, the aim of the invention is to provide a method for calculating the colorimetric cartography of a three-dimensional object by taking into account parameters of the measurement device. In order to do this, the measurement device according to the invention provides the combination of lighting means with monochromatic detection means, of which at least two twin detection means sensitive to substantially identical light wavelength ranges, in order to determine by stereoscopic effect the low-relief of the object analyzed.

More specifically, the object of the invention is a device for the space-colorimetric measurement of a three-dimensional object comprising a detection head made up of an object lighting means and at least four detection means for detecting the light reflected by the object, the device further comprising a unit for processing the data received by the detection means, wherein at least two twin detection means are sensitive to substantially identical light wavelength ranges. The use of at least two twin detection means sensitive to substantially identical light wavelength ranges allows calculating, by stereoscopy, the distance of the analyzed points with respect to the detection means. Thus, the spatial coordinates of the object may be determined according to three directions in space and the colorimetric coordinates may be corrected according to the position of the analysis points with respect to the detection head (distance and normal to the surface). Moreover, the simultaneous implementation of several monochromatic detection means, each sensitive in a complementary manner to a part of the visible wavelength field, allows, by means of a calculation algorithm, composing a digital color image of the analyzed objects. This method brings a better precision than color matrix photonic sensors and an acquisition speed lower than sequential multi-specter monochromatic photonic detection systems.

According to specific embodiments:

the two twin detection means comprise twin filtration members associated to at least one matrix photonic sensor;

the matrix photonic sensor is divided into several areas that respectively receive rays of light coming from each of the twin filtration members.

Thus, the photonic sensor areas do not need to be synchronized with respect to each other;

the matrix photonic sensors are CMOS sensors such that even if a pixel is severely saturated with photons, it has hardly any effect on the neighboring pixels. A bilinear interpolation taking into account the colorimetric values of the pixels surrounding an analysis point is nevertheless provided such as to smooth the results obtained;

the two twin detection means are sensitive to a wavelength range substantially equal to the field of wavelengths of green, which allows to obtain particularly relevant results as to the topology of the objects analyzed;

the two primary detection means are sensitive, one to a range of the wavelength field of blue and the other to a range of the wavelength field of red;

the lighting means are constituted of a central lighting source around which the detection means are arranged;

the lighting means are constituted of an annular lighting source arranged around detection means, which is advantageous as the lighting is thus, substantially homogenous for the set of analysis points;

the detection head is topped with an end cover of predetermined depth such as to reduce the calculation time of the method. In fact, the iterative calculation is thus achieved between a minimum distance substantially corresponding to the depth of the end cover and a maximum distance corresponding to the depth of the observation range.

According to another aspect, the invention also relates to a method for the space-colorimetric measurement of a three-dimensional object comprising the following steps: emitting at least a light to light the object to be analyzed, receiving the rays of light reflected by the object on at least four detection means, and transferring the light information gathered by the detection means towards a processing unit. The rays of light reflected by the object are detected by at least two twin detection means sensitive to substantially identical light wavelength ranges.

According to specific embodiments:

the method comprises a step of calibrating the detection means beforehand;

the processing unit determines, by iterative calculation, the relative position of a plurality of analysis points with respect to the detection head in order to take into account the position of these points with respect to the light source and the detection means to adjust the colorimetric coordinates of the analyzed object.

the processing unit determines, by stereoscopy, the distance of a plurality of analysis points with respect to the detection means;

the processing unit determines the coordinates of the normal to the surface of the object, in a plurality of analysis points;

the iterative calculation of the depth is carried out between a minimum depth, corresponding to the distance between the detection means and the end of an end cover, and a determined maximum depth;

the iterative pitch is substantially equal to the size of the range corresponding to a pixel for the predetermined minimum depth. The measured value is thus substantially isotropic;

the processing unit discards analysis points the intensity of the colorimetric values of which exceeds a value predetermined by calibration such that the errors due to specular reflection be identified;

the method comprises a step of calculating the colorimetric coordinates of a plurality of weighted analysis points according to the position of said analysis points;

the colorimetric coordinates of each point are adjusted by bilinear interpolation such as to respect the linearity of the colorimetry of the analyzed object.

### BRIEF DESCRIPTION OF THE DRAWINGS

Other characteristics and advantages of the invention will become apparent upon reading the following detailed embodiments, with reference to the figs. which respectively illustrate:

FIG. 1, a schematic representation of a measurement device according to the invention;

FIGS. 2a and 2b, schematic representations of a first embodiment of a detection head according to the invention comprising annular lighting means;

FIGS. 3a and 3b, schematic representations of a second embodiment of a detection head according to the invention comprising central lighting means; and

FIG. 4, a schematic representation of the operating of the twin detection means.

### DETAILED DESCRIPTION

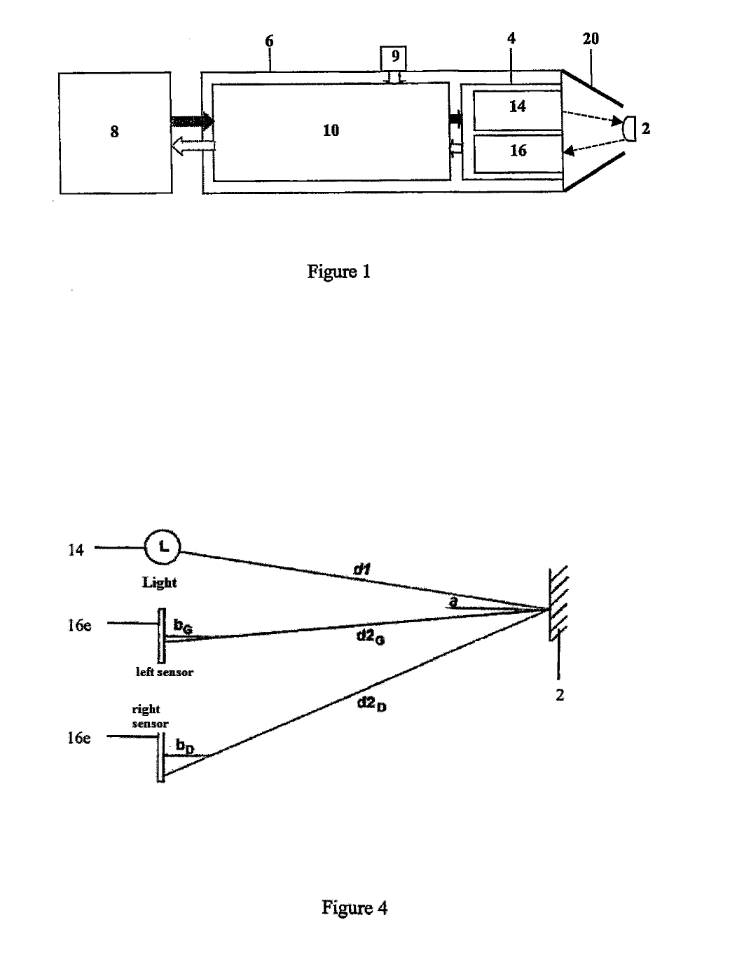

It should be noted that the term isotropic measurement means that the resolution of the measurement is substantially the same according to the three directions in space. An embodiment of a measurement device according to the invention will now be described with reference to FIG. 1. In this embodiment, the device allows to achieve a space-colorimetric measurement of a three-dimensional object 2, in this case a tooth. Of course, any other low-relief three-dimensional object 2, i.e., whereof the topology does not exhibit any clearance, could also be the subject of such a space-colorimetric measurement. For example, the three-dimensional object 2 measured could be a painting, an industrially-produced piece, a ticket, etc.

The device according to the invention preferably comprises a detection head 4 and a support housing 6 connected to a unit for processing 8 data coming from the detection head 4. The processing unit 8 is separated from the support housing 6 and connected thereto by means of communication means 10. This configuration also allows reducing the size of the support housing 6 as well as the production cost of the measurement device. The device is thus compact such as to be able to be easily handled with one hand by an operator. The processing unit 8 may also be integrated within a more stable support 8 in order to improve the precision of results and to measure more voluminous objects 2.

Advantageously, the digital data gathered by the detection head 4 are transmitted, by means of communication means 10, to a processing unit 8 allowing reconstituting by iterative calculation the space-colorimetric coordinates of the analyzed object. These communication means 10 may alternatively have a wire or be wireless. It should be noted that the detection head 4 exhibits dimensions adapted to the size of the three-dimensional object 2 measured in such a way as to reduce the time for processing data provided by the detection head 4 to the processing unit 8.

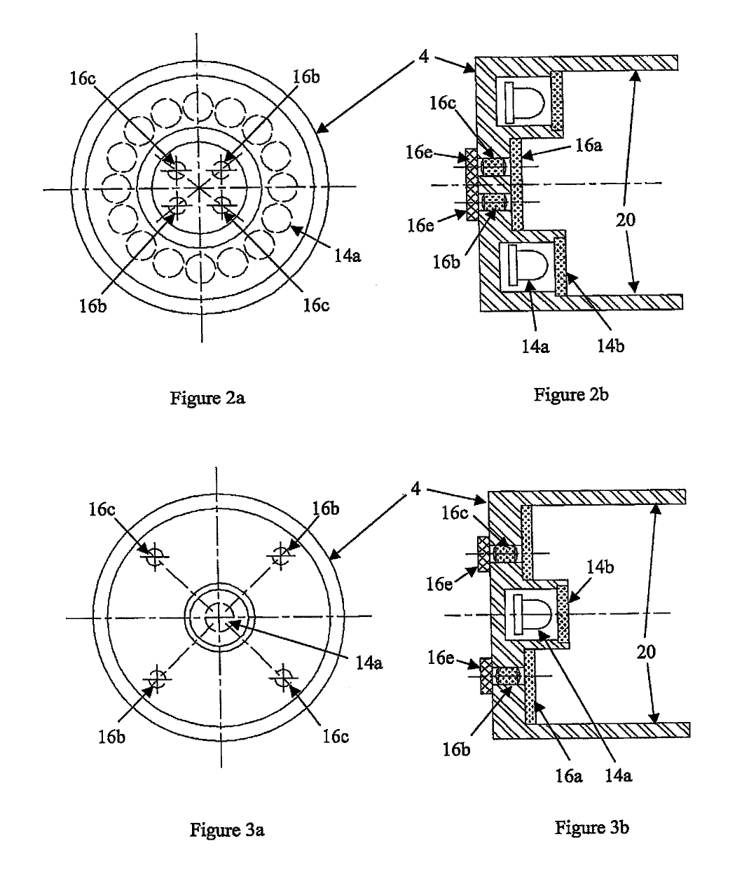

FIGS. 2a and 2b are schematic representations of a first embodiment of a detection head 4 according to the invention. In this example, the detection head 4 comprises central lighting means 14 and four optical detection means 16 arranged around and at equal distance from the central lighting means 14. The annular lighting means 14 comprise wide specter light sources 14a in the visible field. One could consider the possibility to use more or less light sources 14a. Nevertheless the experimental results have shown that starting from eight light sources 14a, the resolution at each analysis point is relatively constant. The lighting provided by the annular lighting means 14 is thus continuous and the power is liable to be adjusted to the measurement requirements. The annular lighting means 14 also advantageously comprise a ground or holographic glass 14b, located downstream from the light source 14a in order to improve the lighting homogeneity. According to an alternative embodiment, the annular light source 14 may be constituted of a circular neon tube.

Advantageously, the optical detection means 16 are constituted of an infrared filter 16a eliminating infrared disturbances which the CMOS-type photonic sensors are sensitive to (presented hereafter). According to an embodiment the infrared filter 16a is a filter BG40 from SCOTT company. The detection means 16 further comprising four filtration members 16b, 16c arranged behind the optical members 16a and at the centre of the annular lighting means 14. Preferably, the filtration members 16b, 16c are lenses allowing at the same time to filter and focus on the rays of light coming from the analyzed object towards the photonic sensors (presented hereafter).

The optical axes of these four filtration members 16b, 16c are substantially parallel to each other and substantially according to the same direction as the propagation axis of the annular lighting means 14. Meanwhile, according to various alternatives, the filtration members 16b, 16c may also exhibit optical axes convergent towards a same point, or towards different points, or even a composition of these various possibilities. One first pair of primary filtration members 16b is constituted of a blue filtration lens, of reference B440 from the HOYA company, and of a red filtration lens of reference DG570 from SCHOTT company. Preferably, this pair of filtration members is arranged symmetrically with respect to the central axis of the annular lighting means 14.

Moreover, the detection means 16 also comprise one pair of twin filtration members 16c exhibiting a substantially identical bandwidth. Advantageously, these twin filtration members 16c are green colors lenses, for example lenses of reference G550 from HOYA company. These twin filtration members 16c are advantageously arranged such as to form a rotational symmetry around the central axis of the annular lighting means 14.

A photonic sensor 16e, subdivided into four quadrants respectively in correspondence with the four filtration members, 16b, 16c, is arranged behind the filtration members 16b, 16c such as to receive the rays of light propagated through these filtration members 16b, 16c. This photonic sensor 16e, is preferably a CMOS sensor. The combination of the twin filtration members 16c with the corresponding photonic sensor zone 16e forms twin detection means (16b, 16c). Likewise, the combination of primary filtration members 16b with the corresponding photonic sensor zone 16e forms the primary detection means (16b, 16e).

According to a second embodiment described with reference to FIGS. 3a and 3b, the detection head 4 is constituted of detection means 16 exhibiting four filtration members 16b, 16c arranged around central lighting means 14, preferably positioned behind a holographic type diffuser filter 14b. According to this embodiment, the detection means 16 exhibiting two primary filtration members 16b, respectively of red and blue colors, and two twin filtration members 16c, of green color 16c. Advantageously, these two twin filtration members 16c, are interposed between the two primary filtration members 16 such as to maintain a symmetry with respect to the rotational axis of the detection head 4. Meanwhile, the twin filtration members 16c may also be arranged side by side.

In this embodiment, the detection head 4 comprises four independent and synchronized photonic sensors 16e, also arranged behind the filtration members 16b, 16c such as to receive the light rays propagated through these filtration members 16b, 16c. The detection head 4 is preferably topped with an end cover 20 of predetermined depth allowing defining a chamber wherein the analyzed object is not disturbed by external light. The depth of the end cover 20 defines the minimum observation depth. In fact, the analyzed object 2 cannot be located at a variable distance with respect to the detection means 16 that correspond to a predetermined tolerated distance in front or behind the nominal distance of the end cover 20.

This end cover 20 exhibits a depth of a few centimeters within the scope of a hand-held measurement device or a few meters within the scope of a device mounted on a support. Advantageously, the depth of the end cover 20 is five times higher than the depth of the object 2 to be measured. Likewise, the width and height of the analyzed object 2 are, preferably, around three times higher than the depth of the object to be measured. In the utilization phase, the device according to the invention may be maintained by means of a support housing 6 and activated thanks to the controlling circuit 9 of the device.

Preferably, the operator first achieves a calibration of the measurement device by placing a white surface against the end cover 20. The duration of the measurement is determined such that the maximum intensity of the photonic sensor(s) does not exceed around 85% of the acceptable maximum intensity. Thus, when taking the measurement, the possible specular effects will be translated by intensity equal to the acceptable maximum intensity and will thus be detectable.

The end cover 20 of the measurement device according to the invention is then placed against the object 2 to be analyzed, such that the object is at least partially protected from outside light. The method according to the invention then consists, in achieving at least one measurement, or non invasive digitizing of a very short period. In fact, this measurement is achieved without contact and by using lighting means 14 of perfect innocuousness. On the other hand, the measurement time may be less than a tenth of a second.

During this second measurement, the rays of light, emanating from the lighting means 14, propagate towards the analyzed object 2 before being reflected towards the detection means 16. Thus, these reflected light beams successively pass through the optical member 16a, then through the filtration members 16b, 16c before reaching the matrix photonic sensors 16e. An optical data corresponding to an analysis point is thus gathered by each of the pixels constituting the matrix photonic sensors 16f. These data are then transmitted towards a processing unit 8, by means of communication means 10 with a central unit 12, in order to deduce the space-colorimetric cartography of the analyzed object 2.

The twin detection means, constituted of the twin filtration members 16c and the corresponding matrix sensors 16e, by stereoscopic calculation in the processing unit 8, allow to determine the space coordinates of each of the analyzed points. In fact, the twin detection means receive the light reflected on the object in the same spectral conditions. In these cases, the values obtained by the twin detection means should be equal.

Within the scope of a measurement device according to the invention exhibiting characteristics represented on FIG. 4, the value of light intensity remitted by a point of the analyzed object may be expressed by the following relations:

$${Lo}_{G} = \frac{{Lp}_{G}}{cos ( {b}_{G} ) \times {d}_{2 G}^{2}} and {Lo}_{D} = \frac{{Lp}_{D}}{cos ( {b}_{D} ) \times {d}_{2 D}^{2}} ,$$

where

L_{oD} represents the value of light intensity re-emitted by an analysis point, determined based on a right sensor;

L_{oG} the value of the light intensity re-emitted by an analysis point, determined based on a left sensor;

L_{pD}, the light energy received by the pixel of the right sensor after a diffuse reflection on the object;

L_{pG}, the light energy received by the pixel of the left sensor after a diffuse reflection on the object;

b_{D}, the angle between the normal of the right sensor at one pixel and the ray from the object;

b_{G}, the angle between the normal of the left sensor at one pixel and the beam from the object;

d_{2D}, the length of the light path from the analysis point to the corresponding pixel on the right sensor; and

d_{2G} the length of the light path from the analysis point to the corresponding pixel on the left sensor.

Consequently, the method according to the invention provides to calculate in an iterative manner, for each potential depth of an analysis point comprised between a predetermined minimum depth and a maximum depth, the depth for which the values of light intensity (L_{OG}, L_{OD}) re-emitted by an analysis point and calculated based on twin detection means, are the closest. It is worth noting that the minimum depth advantageously corresponds to the depth of the end cover 20 whereas the maximum depth corresponds to the depth of the observation range. Preferably, the iteration pitch is substantially equal to the size of the range corresponding to a pixel for the predetermined minimum depth.

The processing unit 8 determines at this stage a couple of data corresponding to the depth of a plurality of analysis points and the light intensity re-emitted by said analysis points corresponding to the length range of the twin detection means. The processing unit thus deduces, the coordinates (x, y, z) of each analysis point of the measured object. Based on these data, the processing unit 8 also determines the normal at each analysis point in order to be able to restore the colour at this analysis point. This operation is carried out by calculating the mid-plane passing through each analysis point.

The processing unit 8 finally determines, based on values of light intensity gathered by primary and twin detection means, the colorimetric cartography of the analyzed object. This cartography is weighed according to the space position of the analysis points and particularly the distance of these analysis points with respect to the detection means 16 as well as the direction of the normal to the surface of the object at each of these analysis points. It may be possible to achieve several measurement sets such as to increase the precision of the results.

The invention is not limited to the embodiments described and represented above. Particularly, the skilled person is able to achieve various alternatives of the abovementioned device and method within the framework of the invention. Particularly, although it is preferable to use monochromatic filtration lenses the filtration members 16b, 16c may be composed of lenses combined with colour filters. Furthermore, the device according to the invention may also be composed of four pairs of detection means 16 or more, in order to improve the quality of the results, specifically on the colorimetric plane. On the other hand, it would be also considered possible to replace the CMOS matrix photonic sensors by CDD sensors or any other type of photonic sensor.

1. A device for the space-colorimetric measurement of a three-dimensional object comprising a detection head made up of object lighting and at least four detectors for detecting light reflected by the object, a unit processing the data received by the detectors, and at least two twin detectors being sensitive to substantially identical light wavelength ranges.

2. The device according to claim 1, wherein both twin detectors comprise twin filtration members associated to at least one matrix photonic sensor.

3. The device according to claim 2, wherein the matrix photonic sensor is divided into several zones respectively receiving the rays of light coming from each of the twin filtration members.

4. The device according to claim 3, wherein the matrix photonic sensors are CMOS sensors.

5. The device according to claim 1, wherein both twin detectors are sensitive to one wavelength range substantially equal to the range of green wavelengths.

6. The device according to claim 1, wherein the two primary detectors are sensitive, one to a range of the field of the blue wavelengths, and the other to a range of the field of the red wavelengths.

7. The device according to claim 1, wherein the lighting comprises a central light source around which the detectors are arranged.

8. The device according to claim 1, wherein the lighting comprises an annular lighting source arranged around the detectors.

9. The device according to claim 1, wherein the detection head is topped by an end cover of predetermined depth.

10. A method for the space-colorimetric measurement of a three-dimensional object comprising:
i. emitting at least a ray of light to lighten the object to be analyzed;
ii. receiving the rays of light reflected by the object on at least four primary detectors; and
iii. transferring the light information gathered by the detectors towards a processing unit;
wherein the light beams reflected by the object are detected by at least two twin detectors sensitive to substantially identical light wavelength ranges.

11. The method according to claim 10, comprising calibrating the primary detectors beforehand.

12. The method according to claim 10, wherein the processing unit determines, by iterative calculation, the relative position of a plurality of analysis points with respect to the detection head.

13. The method according to claim 12, wherein the processing unit determines, by stereoscopy, the distance of a plurality of analysis points with respect to the primary detectors.

14. The method according to claim 12, wherein the processing unit determines the coordinates of the normal to the surface of the object, in a plurality of analysis points.

15. The method according to claim 12, wherein the iterative calculation of the depth is achieved between a minimum depth, corresponding to the distance between the primary detectors and the end of an end cover, and a predetermined maximum depth.

16. The method according to claim 12, wherein the iterative pitch is substantially equal to the size of the range corresponding to a pixel for the predetermined minimum depth.

17. The method according to claim 10, wherein the processing unit discards analysis points the intensity of colorimetric values of which exceeds a value predetermined by calibration.

18. The method according to claim 17, comprising a step of calculating colorimetric coordinates of a plurality of weighted analysis points according to the position of the analysis points.

19. The method according to claim 17, wherein the colorimetric coordinates of each point are adjusted by bilinear interpolation.
